(19) United States
(12) Patent Application Publication
(10) Pub. No.: US 2007/0180312 A1
(43) Pub. Date: Aug. 2, 2007

(54) Software duplication

(75) Inventors: James E. Rhodes, Boulder, CO (US); Walter P. Christmas, Corrales, NM (US)

Correspondence Address: SHERIDAN ROSS P.C., 1560 BROADWAY, SUITE 1200, DENVER, CO, 80202, US

(73) Assignee: Avaya Technology LLC, Basking Ridge, NJ (US)

(21) Appl. No.: 11/480,173

(22) Filed: Jun. 30, 2006

Related U.S. Application Data
(60) Provisional application No. 60/764,718, filed on Feb. 1, 2006.

(51) Int. Cl. G06F 11/00

(52) U.S. Cl. 714/13

(57) ABSTRACT

In one embodiment, the present invention is directed to a software duplication process in which write faults are used to track memory areas that have been changed by the active processor.

### CROSS REFERENCE TO RELATED APPLICATION

The present application claims the benefits of U.S. Provisional Application Ser. No. 60/764,718, filed Feb. 1, 2006, of the same title, to Rhodes, et al., which is incorporated herein by this reference.

### FIELD OF THE INVENTION

The invention relates generally to replicated high-reliability processing systems and particularly to duplicated-memory systems.

### BACKGROUND OF THE INVENTION

High-reliability processing systems often require duplication of the processor (including processor memory) so that it is not a single-point-of-failure in the system. Usually, one processor is active and runs the system, and the other processor is kept in “standby” mode, where it is continually updated with copies of memory-write transactions occurring in the active processor (this updating process is called “shadowing”). If the active processor has a fault, then the system switches to the standby processor and continues the system's processing tasks virtually glitchlessly, since it has knowledge of the state of the active processor at the time of the failure.

A commonly-used shadowing method copies all data from the active processor to the standby processor's memory, even though only a portion of it is actually needed for the standby processor to continue operating the system in the event of an active processor fault. This method of shadowing has become a serious bottleneck for high-performance processing systems. It reduces the overall system performance, as it usually takes longer to transfer data from the active processor to the standby processor than it takes to perform a normal memory-write operation on the active processor.

One method of shadowing is known as “hardware-assisted duplication” or “hardware duplication”. In hardware duplication, hardware controls duplication operations effected between the primary and standby processors. The application process itself sees only accesses to shared memory. A duplication manager maps the memory to an input/output space, and hardware handles transmission of the shadowed information to the standby processor. Although hardware duplication can have a minimal impact on software processes, provide increased levels of system performance, and have a minimal impact on software development costs, it often requires custom hardware boards, requires costly hardware development and maintenance of hardware compatibility, and experiences constraints from mapping of memory to the input/output bus.

Another known method of shadowing is called “transaction-based duplication” or “software duplication”. In software duplication, the active processor sends information about what functions it is performing to the standby processor, and the standby processor duplicates these functions and, in the process, updates its memory state to be that of the active processor. While it has very little hardware impact and has no server dependencies, other than the need for a transaction channel from the active to the standby processor, the complexity of the method lies in the software. The reason for the complexity is that all of the application's code must be able to perform, and must actively manage, the duplication function. Software duplication can require substantial Central Processing Unit or CPU resources to perform all facets of duplication processing.

What the prior art lacks is a shadowing method that enables dynamic tracking of which portions of memory have been changed by the shadowed application processes in the active processing system during a selected interval.

### SUMMARY OF THE INVENTION

These and other needs are addressed by the various embodiments and configurations of the present invention. The invention is generally directed to a method which controls the state of a plurality of selected or designated memory areas (e.g., locations or blocks such as pages) to track write operations by an application process that is being shadowed. As will be appreciated, a “page” refers to segment of memory of a selected size, which is typically the same as the atomic size of the host processor. The page size is commonly around 4,000 bytes. Typically, the microprocessor manages the memory segments individually and simulates larger memory endowment by swapping pages of code and data into physical memory as it is needed (on demand).

In one configuration, the states of all of the pages corresponding to (or used by) the application process are initially set to a “locked” state, such as a read-only state. When the application process attempts to write data to one of the locked pages, the processor detects a write fault. The faults are used to identify and track those memory areas that have changed since the last synchronization between the primary and backup processing systems. In response to the fault, the state of the particular memory page is changed to an “unlocked” state, such as a read/write state. The application process is then enabled to write the data to the particular memory page. The process is repeated memory page-by-memory page as the application process processes information.

At selected intervals, the information on the written or altered memory pages is collected and forwarded to the backup processing system, which then replicates the changes in appropriate locations in its memory. As will be appreciated, each location in the memory of the standby processing system contains a mirror image of the pre-changed information in a corresponding memory area of the primary processing system. Any memory area which is still in the “locked” state is normally not shadowed on the backup processing system as it has not been changed since the last data synchronization between the two processing systems.

In this configuration, the invention uses the characteristics of a processor, which are normally used for setting memory protection regions, to set an area of memory to a first state (e.g., read-only) and have the processor notify shadowing logic of attempted modification of the memory area. The processor notification is the trigger for shadowing or replicating the memory area to the standby processing system. In other words, the invention uses the very mechanism designed to prevent changes to selected memory areas to do the opposite, namely to receive notification of and allow memory area changes. The shadowing mechanism thus not only uses the built-in memory management capability of the processor to provide the support for detecting and duplicating writes by the active processing system but also is transparent to the application's operations.

The invention is a form of software duplication and can provide a new method of transferring processor data from an active processor to one or more standby processors in a duplicated-processor environment, that allows for control over what data is transferred and what data is not. This can reduce the overall number of system writes that need to be transferred to the standby processor and therefore lead to a direct performance enhancement on the active processor by allowing dynamic changes to be made to the indication of what areas of memory are shadowed while lessening the needed bandwidth to effect shadowing. Unlike hardware-assisted duplication where the processing system has small transactions (e.g., one word), the page size of software duplication can lend itself to being more affected by incorrect coding practices and large manipulation of data. The mechanism can also permit the detection of the frequency of writes to memory areas, thereby removing, partially or completely, code points, or “hooks”, embedded in the code of the shadowed application processes, that negatively affect the performance of software duplication.

It can allow for dynamic control of shadowing. Dynamic control of shadowing in turn can allow the system to support such features as “soft” switches, for example. Soft switches occur when the active and standby processors have identical memory images, and the standby processor begins executing instructions immediately after the active processor releases control to the newly-active (previously-standby) processor. This can allow for a seamless transfer of system control from one processor to another.

When an area of the memory is allocated (e.g., by an active processor's operating system) to an entity (e.g., a program), a determination can be made whether the memory area allocated to the entity is to be shadowed. This determination will cause the memory area to be placed initially in the locked state (if it is to be shadowed) or the unlocked state (if it is not to be shadowed).

The invention can shield all software except a duplication system (which controls the states of the memory areas) from knowledge of how to effect shadowing. It can thus reduce the real-time requirements on the active processor, which would otherwise have to generate transaction-based duplication messages for all functions requiring duplication. Moreover, it “hides” shadowing decisions from application process developers, because the state of the memory areas keeps track of which areas of memory are shadowed and which are not. This can improve time-to-market by reducing system code development, since the application process' code need not be written to be able to perform, and to correctly handle, duplication transactions. Furthermore, handling of shadowing decisions using the state of the memory areas can have real-time savings, since no application process' code needs to be executed to generate and handle transaction-based data-duplication messages.

The invention can use an end-to-end Transport Control Protocol or TCP connection to effect transmission of duplication information between the active or primary and standby processing systems. This type of connection can provide a routable, repeatable, and remoteable standard. The connection can further provide security through the use of various encryption protocols, such as the Advanced Encryption Standard or AES, that are compatible with the TCP/IP suite of protocols.

These and other advantages will be apparent from the disclosure of the invention(s) contained herein.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

The above-described embodiments and configurations are neither complete nor exhaustive. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram of duplicated processing systems according to an embodiment of the present invention;

FIG. 2 is a signal flow diagram depicting the various signals exchanged among the logic components according to an embodiment of the present invention;

FIG. 3 depicts a plurality of memory areas having differing states according to an embodiment of the present invention; and

FIG. 4 is a block diagram of a set of memory areas according to an embodiment of the present invention.

### DETAILED DESCRIPTION

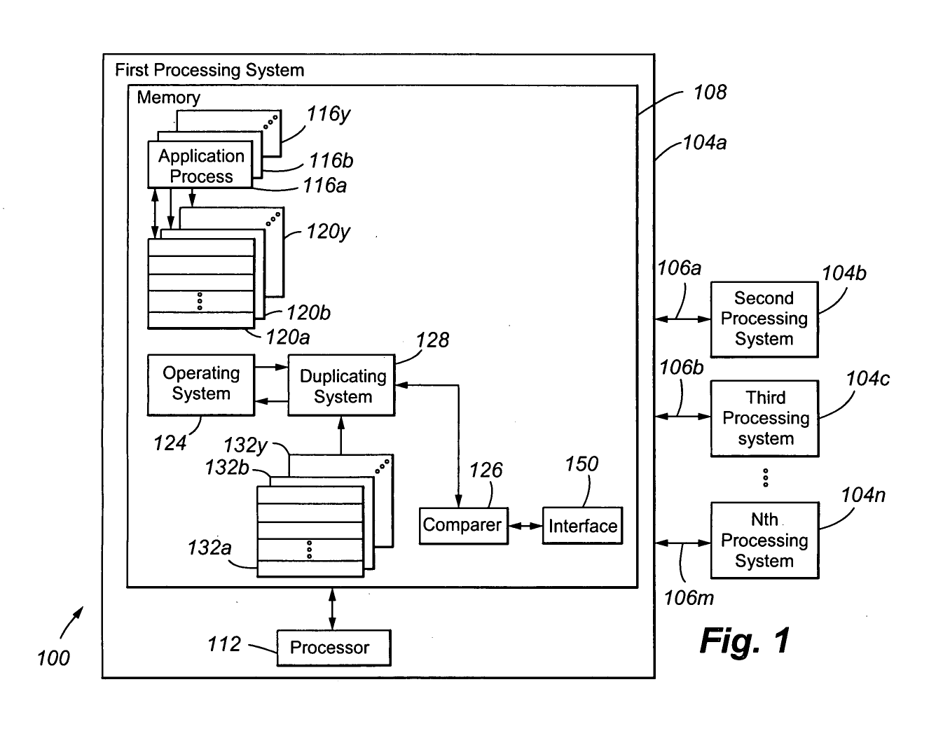

FIG. 1 shows a duplicated-processing system 100 that includes first, second, third, and nth processing systems 104a-n connected by a plurality of duplication links 106a-m. System 100 normally operates in an active-standby configuration, with the first processing system 104a being active and the second . . . nth processing systems being on standby. Although multiple standby processing systems are shown, it is to be understood that only one standby processing system may be deployed, with the number depending on the particular application process. As will be appreciated, the active processing system performs the system's processing tasks, and the inactive processing system is standing by to become the active processing system should the currently-active processing system fail.

Each processing system 104 includes a memory 108 and processor 112. The memory 108 refers to addressable storage space and other internal storages used to execute instructions. It is normally a combination of read-only and writable memory. The processor 108 is a functional unit that interprets and executes instructions. It normally includes one or more instruction control units and an arithmetic and logic unit.

Preferably, the processor is a standard microprocessor, such as a Pentium™ microprocessor.

Memory 108 further includes a plurality of application processes 116a-y for performing specified sets of operations in the form of transactions and a corresponding plurality of primary sets of memory areas 120a-y to receive and store the output of the operations, an operating system 124 for controlling the execution of programs and providing services, such as resource allocation, scheduling, input/output control and data management, a duplication system 128 for controlling the states of the memory areas 120a-y and controlling shadowing operations, secondary sets of memory areas 132a-y (which may duplicate and correspond to the primary sets of memory areas 120a-y) for receiving and storing information from a respective memory area 120a-y, a comparer 126 for comparing information in the primary sets of memory areas at a first selected time against information in the primary sets of memory areas at a second (later) selected time to determine informational differences or changes, and an interface 150 for reading sets of changed information from the comparer 126, assembling and packetizing the changed information into a serial stream of information and transmitting the packetized information, with suitable error checking information (e.g., Cyclic Redundancy Check or CRC, and the like) included, simultaneously or at different times, to each of the standby processing systems. In one configuration, the memory includes a shared memory space (which may be part of the second set of memory areas) that includes information on each application process that is a client of the duplication system 128, information on each memory area that is being duplicated, and queue headers and shadowing buffer entries to hold the information in each altered memory area. The secondary sets of memory areas 132a-y can be implemented as a buffer and do not need to have a one-to-one correspondence with the primary sets of memory areas.

As will be appreciated, software duplication involves two primary activities, namely data shadowing and refresh. A refresh is the process of copying all the duplicated memory pages from the active processing system to the standby processing system to bring the standby processing system's memory in sync with the active processing system's memory. A refresh occurs before data shadowing begins. A refresh occurs before data shadowing begins. This is to ensure that all of the data on the standby processing system is completely in sync with the active processing system. Prior to the refresh the two systems (active and standby) are not in sync and all of the memory on the active processing system is in read-write state. All data on the standby processing system is considered to be invalid. In one configuration, refresh is initiated by sequentially marking each segment of memory to be duplicated to the read-only state and forcing all pages of that segment to be duplicated to the standby processing system. As each segment is duplicated it starts the normal detection of writes by the application and shadowing that data to the standby. Thus, the refresh can occur while the application is processing data and can also be sequenced segment-by-segment so as not to affect processing on the active processing system. The standby is considered in sync when all of the segments of memory on the active system have been refreshed and are being shadowed to the standby processing system.

Data shadowing is the ongoing process of keeping the active and standby processing systems in sync by sending newly changed memory pages to the standby processing system as the changes occur. This mode is entered into after the refresh mode is performed and all of the sets of primary memory areas in the standby processing system are deemed to have a valid state.

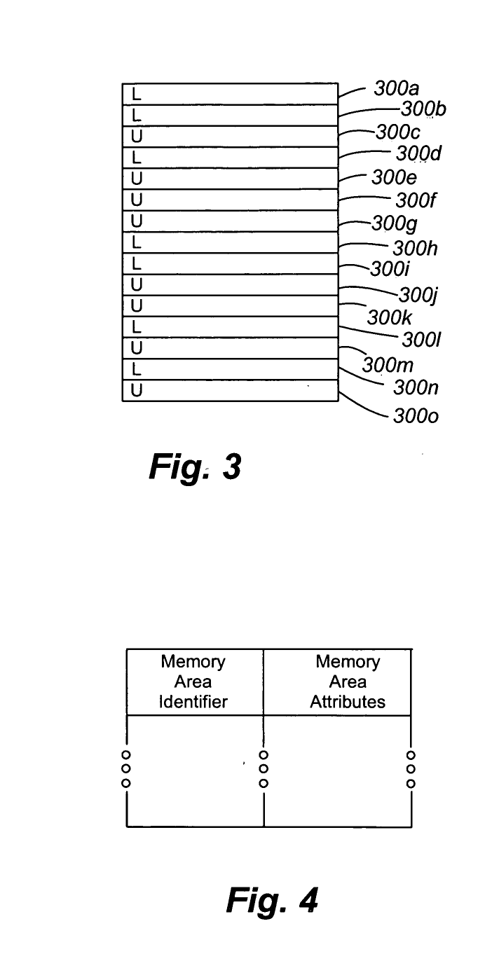

FIG. 3 depicts a particular configuration of the invention. In the configuration, the memory areas correspond to memory pages. As noted, the primary set of memory pages have various states. Thus, each memory page has one of two binary states, either locked or unlocked. In FIG. 3, memory pages 300a, b, d, h, i, l, and n are in the locked (or unaltered) state while pages 300c, e, f, g, j, k, m, and 0 are in the unlocked (or altered state).

In this configuration, when a write fault is received by the duplication system 128 the page that is the subject of the write fault is flagged as “dirty”. A copy of the “clean” page (or the page before any changes are made in response to the write command) is stored in a duplication file, or one of the secondary sets of memory areas 132, and marked as the “clean” version. The page is then marked as being readable/writable and the write operation is allowed. At the end of a transaction, all pages that are flagged as being “dirty” are again marked as being read-only and compared with the “clean” version of the corresponding page that is stored in a duplication file. The differences are then written to the standby processing system. As will be appreciated, the trigger for processing the dirty pages and forwarding the differences to the standby processing system is not limited to transaction completion. Other possible triggers include the passage of a selected amount of time, capacity constraints of the shadow buffer and/or secondary set of memory areas, a count of the number of memory areas changed, a hook, and combinations thereof.

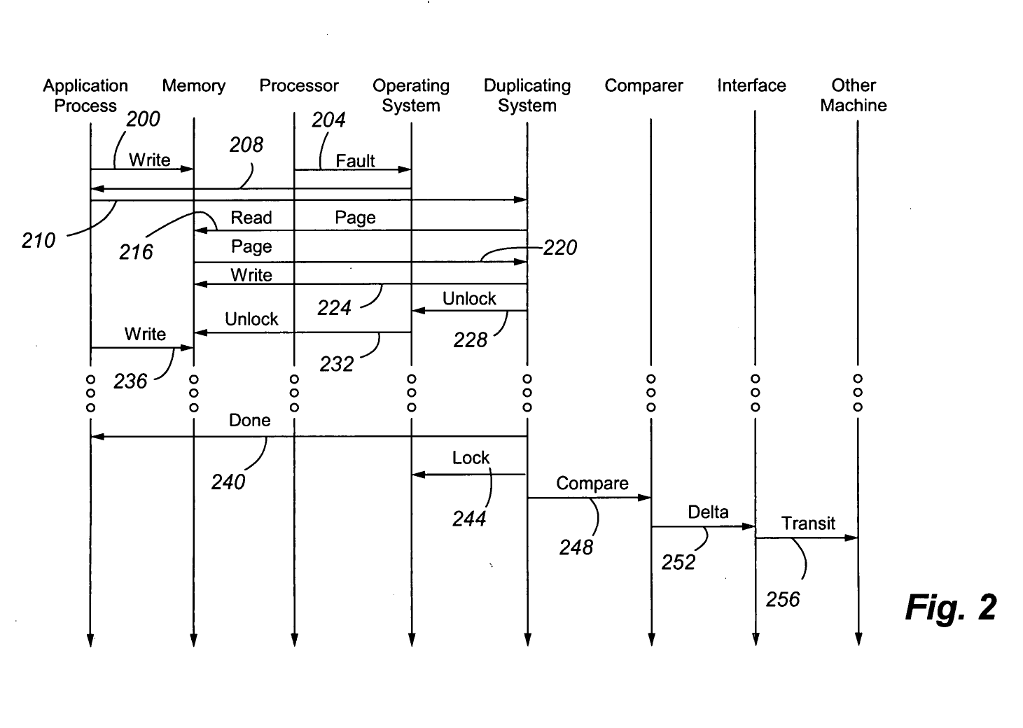

FIG. 2 illustrates the operation of the data shadowing mechanism according to an embodiment of the invention. The signals of FIG. 2 are transmitted in parallel application process-by-application process. Before the depicted signals are exchanged by the components, the primary sets of memory areas 120a-y (to be accessed by the application processes and shadowed or duplicated by the standby processing system) are placed in the locked, or read-only, state. Further, the application processes are registered as clients by duplication system 128 and obtain access to the duplication shared memory area, and the duplication system uses information compiled in the application process to identity the areas of memory (or the selected application process' respective primary memory area set) that are duplicated and what are the characteristics of each area. As will be appreciated, each application process commonly has defined or selected code points that define the beginning and end of a transaction.

For a selected application process, the process is initiated when the application process 116 forwards a write command 200 to the interface of the memory to write to a selected memory area (e.g., memory page). Because the selected memory area is locked, any attempt to write to the memory area is a write fault detected by the processor 112. For example, the fault is, in one configuration, a segmentation violation signal having the specific code that the memory page is being written in a read-only environment. In response, the processor 112 forwards a fault message 204 indicating the nature of the fault to the operating system 124 and including a memory identifier identifying the affected memory area. An example of a memory identifier is memory address. The operating system 124 then forwards an interrupt command 208 to the application process, which makes a call 210 to the duplication system 128 indicating the existence and nature of a fault and identifying the memory page, typically by memory address.

In response, the duplication system 128 first determines the answers to two queries, namely:
(a) Was the fault due to a permission violation?
(b) Was the area of the memory affected in the address range of a duplicated segment for that application process?
   If the answer to either (a) or (b) is no, the fault is not due to an attempt to write to a locked page, and the normal error fault mechanism of the application process continues. If answers to both (a) and (b) are yes, the duplication system 128 logs, in the application processes' corresponding shadowing buffer (shown below) in the shared memory space, the memory address of the memory area subject to the write fault, forwards a read message 212 to the memory interface (not shown) of the memory to read the (unaltered) contents of the memory area subject to the fault. The memory interface returns 216 the contents of the memory area to the duplication system 128, which then commands 224 the interface to write the contents to a suitable memory area in a respective secondary set of memory areas 132a-y.

FIG. 4 shows a shadowing buffer or table 400 maintained by the duplication system 128. Each time a write fault is received, the duplication system 128 adds to the list a memory area identifier (which typically is a memory address associated with the memory area subject to the fault) and, optionally, attributes of the memory area. In another configuration, the table 400 includes a listing of all memory area identifiers used by a selected application. Whenever a write fault is received for a memory area, an indicator flag is set to show that the memory area has been altered since the last data synchronization.

Returning to FIG. 2, the duplication system 128 then commands 228 the operating system 124 to place the memory area in the unlocked state, thereby permitting it to be written to. The operating system 124, in response, commands 232 the memory interface to set the state of the memory area to “unlocked”. This means that any further writes to the now unlocked (dirty) page will be at normal speed until the state of the page is changed back to “locked.”

After the application process' write command failed, the application process reissues the write command 236 to the now unlocked memory area. Because the memory area is now unlocked, the application process is able to write the desired information to the memory area.

The preceding steps are repeated for the selected application process write command-by-write command until a selected point in time (or the occurrence of a first event), when data synchronization with the shadowing standby processing system is to be performed. The selected point in time may be based on a number of events, including a clock setting, a count of a selected parameter (e.g., a number of pages altered, a number of alterations, and like), an available secondary memory capacity, and the like. In one configuration, when the application process reaches the end of a transaction it calls a function in the duplication system to process all dirty pages and return the process to a stable state. The function loops through every dirty page stored in the shadowing buffer.

When the selected point in time is reached, the duplication system 128 issues a “done” command 240 to the selected application process to temporarily suspend output to the corresponding primary set of memory areas, commands 244 the operating system 124 to set the state of the memory areas in the corresponding primary set of memory areas to “locked” or the page to “clean”, and commands 248 the comparer 126 to read the contents or images of one or more of the secondary sets of memory areas 132 and compare the images, memory area-by-memory area, to the images of the corresponding primary set of memory areas 120 to determine the delta, or the information that has changed. Memory areas in the locked state are normally not read as they have not changed since the previous synchronization.

The comparer 126 provides 252 a set of changed information from each memory page to the interface 150. The changed information is normally an offset and value of the current image of the memory area. In one configuration, as the comparer processes the memory areas, the original image of each memory area in the secondary set of memory areas is replaced with the data from the current image of the memory area and a list of the differences detected between the original and altered images. In another configuration, the entire contents of the dirty page is sent to the standby processing system when the number of differences between the original (unaltered) page in the secondary set of memory areas and the dirty page in the primary set of memory areas exceeds a selected threshold.

After all of the processing in the secondary sets of memory areas is completed by the comparer, the images in the memory areas are moved (linked to the tail of an outbound queue maintained by the interface 150). A new set of secondary memory areas is obtained for the application process, and the process is allowed to continue with another transaction. The interface 150 assembles and packetizes the changed information and/or, depending on the configuration, the complete contents of the dirty page itself into a serial stream of information, and transmits, over a duplication link 106, the packetized information, typically as an encrypted communication and with suitable error checking information (e.g., Cyclic Redundancy Check or CRC, rolling checksum, and the like) included, to the appropriate standby processing system or to multiple standby processing systems. The standby processing system compares the error checking information against the error checking information on the same page on the standby processing system after the changed information is applied to that page. If the error checking mechanism detects an error (e.g., the rolling checksum fails to match the value of the rolling checksum created on the same page on the standby processing system after the differences are applied), the memory area, or page, states are no longer assumed to be in sync. In that event, a refresh may be performed to bring the memory areas back in sync. In one configuration, individual page updates are requested by the standby processing system, and fall back into total refresh only occurs if there are a significant number of errors in any interval.

Because all of the memory areas in the primary set of memory areas have been reset to the first state, the duplication system 128 then repeats operations 216, 224, and 228, memory page-by-memory page until a selected event or trigger occurs, causing the changes to the information in the primary set of memory areas to again be sent to the standby processing system(s).

In an alternative embodiment, the duplication system 128 stores the addresses of each of the altered memory areas and sends the full contents of each of the altered memory areas to the standby processing system. This embodiment is useful where the available bandwidth of the duplication link 106 is not a concern.

The standby processing system receives the duplication information, whether in the form of page-by-page differences or complete pages, updates the current images of each page in its primary set of memory areas, and stores the updated images temporarily in its secondary set of memory areas. Only after the error checking mechanism confirms that all of the updated and temporarily stored pages are in sync with the corresponding pages on the primary processing system are the updated pages copied into the standby processing system's primary set of memory areas. This delayed update of the standby processing system's primary set of memory areas ensures that the standby processing system has, at any one point in time, a valid set of images in its primary set of memory areas, or, stated another way, that the information in its primary set of memory areas correctly matches the information in the primary set of memory areas of the primary processing system at some prior point in time.

A number of variations and modifications of the invention can be used. It would be possible to provide for some features of the invention without providing others.

For example in one alternative embodiment, the invention is employed not only in processing architectures using one primary and N standby processing systems but also in architectures using N primary and M standby processing systems or using N primary and one standby processing systems.

In another alternative embodiment, the invention is used for performance profiling to track or monitor the performance of a processing system. The invention permits the monitoring system to track everything that the monitored processing system is doing in memory.

In a further alternative embodiment, the primary set of memory areas are set to the first state when the images are loaded in the areas and/or, when the processing system is booted, the firmware causes the memory areas to be set to the first state. In either case, the duplication system does not itself control the initial state setting of the primary set of memory areas.

In a further alternative embodiment, the primary processing system has more than one processor. Due to the increase in processing resources, the updates to the standby processing system(s) can be sent more frequently. Each processor can perform a subset of the operations described above.

In yet another alternative embodiment, dedicated hardware implementations including, but not limited to, Application Specific Integrated Circuits or ASICs, programmable logic arrays, and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be stated that the software implementations of the present invention are optionally stored on a tangible storage medium, such as a magnetic medium like a disk or tape, a magneto-optical or optical medium like a disk, or a solid state medium like a memory card or other package that houses one or more read-only (non-volatile) memories. A digital file attachment to e-mail or other self-contained information archive or set of archives is considered a distribution medium equivalent to a tangible storage medium. Accordingly, the invention is considered to include a tangible storage medium or distribution medium and prior art-recognized equivalents and successor media, in which the software implementations of the present invention are stored.

Although the present invention describes components and functions implemented in the embodiments with reference to particular standards and protocols, the invention is not limited to such standards and protocols. Other similar standards and protocols not mentioned herein are in existence and are considered to be included in the present invention. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present invention.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A duplication method, comprising:
(a) setting at least one memory area to a first state in which the at least one memory area is read-only;
(b) in response to an attempt to write to the at least one memory area, receiving a notification that a write fault has occurred;
(c) changing the first state of the at least one memory area to a second state in which the at least one memory area is writable; and
(d) providing to a standby processing system for replication, at least some of the alterations to the at least one memory area.

2. The method of claim 1, wherein the at least one memory area comprises a plurality of memory areas, each memory area having a unique memory identifier, and further comprising:
(e) indicating the memory identifiers of each of the memory areas that has been changed to the second state.

3. The method of claim 2, wherein, in the providing step (d), contents of memory areas that are still in the first state are not provided to the standby processing system.

4. The method of claim 1, wherein the at least one memory area comprises a plurality of memory areas, further comprising:
(e) after step (d), resetting each of the memory areas in the second state to the first state; and
repeating steps (a) through (d).

5. The method of claim 1, further comprising:
(e) identifying, based on information compiled in an application process, a set of memory areas to be duplicated and at least one characteristic of each area in the set;
(f) when the notification is received, determining whether the fault is due to a permission violation and whether the at least one area is in the memory area set;
(g) when the fault is not due to a permission violation and the at least one area is a member of the memory area set, performing steps (c) and (d) with respect to the at least one memory area; and
(h) when the fault is due to a permission violation or the at least one area is not a member of the memory area set, not performing steps (c) and (d) with respect to the write fault.

6. The method of claim 1, wherein step (c) comprises the substeps:
(c1) indicating at a first selected memory location that the at least one memory area has been changed;
(c2) recording the original contents of the at least one memory area to a second selected memory location; and
(c3) thereafter changing the first state of the at least one memory area to a second state in which the at least one memory area is writable.

7. The method of claim 6, wherein, upon the occurrence of a first event, step
(d) is performed and wherein step (d) comprises the substeps:
(d1) determining the differences between the original contents of the at least one memory area and the current contents of the at least one memory area, the differences being the alterations;
(d2) providing the alterations to the standby processing system; and
(d3) resetting the at least one memory area to the first state.

8. The method of claim 7, wherein the first event is at least one of clock setting, a count of a selected parameter, an available capacity of at least a segment of memory, a loss of synchronization between the primary and standby processing systems, and the completion of a transaction.

9. The method of claim 1, wherein the standby processing system has at least one standby memory area comprising an earlier version of the information currently in the at least one memory area and wherein the standby processing system receives, with the at least some of the alterations, a checksum associated with the current information of the at least one memory area, and further comprising:
(e) the standby processing system applying the at least some alterations to the earlier version of the information to form updated information;
(f) the standby processing system determining whether the checksum is valid for the updated information;
(g) when the checksum is not valid for the updated information, initiating a refresh of the contents of the at least one standby memory area; and
(h) when the checksum is valid for the updated information, copying the updated information to the at least one standby memory area.

10. A computer readable medium comprising processor-executable instructions to perform the steps of claim 1.

11. A method, comprising:
(a) setting a plurality of memory areas to a first state in which each of the memory areas is read-only;
(b) in response to an attempt, by an application process, to write to a first memory area, receiving a notification that a write fault has occurred with respect to the first memory area;
(c) changing the first state of the first memory area to a second state in which the first memory area is writable; and
(d) tracking which of the plurality of memory areas have been changed to the second state to monitor operation of the application process.

12. The method of claim 11, wherein each of the memory areas has a unique memory identifier and wherein the tracking step (d) comprises the substeps:
(d1) indicating the memory identifiers of each of the memory areas that has been changed to the second state; and
(d2) providing to a standby processing system for replication, at least some of the alterations to each of the changed memory areas, wherein contents of memory areas that are still in the first state are not provided to the standby processing system.

13. The method of claim 12, wherein step (d) further comprises the substeps:
(d3) recording the original contents of the first memory area to a selected memory location; and
(d4) thereafter changing the first state of the first memory area to a second state in which the at least one memory area is writable.

14. The method of claim 13, wherein, upon the occurrence of a first event, step (d2) is performed and wherein step (d2) comprises the substeps:
(d2A) determining the differences between the original contents of the first memory area and the current contents of the first memory area, the differences being the alterations; and
(d2B) providing the alterations to the standby processing system.

15. The method of claim 14, wherein the first event is at least one of clock setting, a count of a selected parameter, an available capacity of at least a segment of memory, a loss of synchronization between the primary and standby processing systems, and the completion of a transaction.

16. A computer readable medium comprising processor-executable instructions to perform the steps of claim 11.

17. A duplicated processing system, comprising:
(a) an active processing system, the active processing system comprising:
(i) a processor;
(ii) a memory comprising at least one memory area and an application process accessing the at least one memory area; and
(iii) a duplication system; and
(b) a standby processing system operable to perform the functions of the active processing system in the event that the active processing system malfunctions, wherein the duplication system is operable to:
set the at least one memory area to a first state in which the at least one memory area is read-only;
in response to an attempt to write to the at least one memory area, receive a notification that a write fault has occurred;
change the first state of the at least one memory area to a second state in which the at least one memory area is writable; and
provide to the standby processing system for replication, at least some of the alterations to the at least one memory area.

18. The system of claim 17, wherein the at least one memory area comprises a plurality of memory areas, each memory area having a unique memory identifier, and wherein the duplication system is operable to indicate the memory identifiers of each of the memory areas that has been changed to the second state.

19. The system of claim 18, wherein the contents of memory areas that are still in the first state are not provided to the standby processing system.

20. The system of claim 17, wherein the at least one memory area comprises a plurality of memory areas and wherein the duplication system resets each of the memory areas in the second state to the first state after the alterations are provided to the standby processing system and repeats the operations of claim 17.

21. The system of claim 17, wherein the duplication system further:
identifies, based on information compiled in an application process, a set of memory areas to be duplicated and at least one characteristic of each area in the set;
when the notification is received, determines whether the fault is due to a permission violation and whether the at least one area is in the memory area set;
when the fault is not due to a permission violation and the at least one area is a member of the memory area set, changes the first state of the at least one area to the second state and provides the alterations to the standby processing system; and
when the fault is due to a permission violation or the at least one area is not a member of the memory area set, neither changing the first state of the at least one area to the second state nor providing the alterations to the standby processing system with respect to the write fault.

22. The system of claim 17, wherein the duplication system:
indicates at a first selected memory location that the at least one memory area has been changed;
records the original contents of the at least one memory area to a second selected memory location; and thereafter changes the first state of the at least one memory area to a second state in which the at least one memory area is writable.

23. The system of claim 22, wherein the alterations are provided to the standby system upon the occurrence of a first event and wherein the duplication system determines the differences between the original contents of the at least one memory area and the current contents of the at least one memory area, the differences being the alterations, provides the alterations to the standby processing system, and resets the at least one memory area to the first state.

24. The system of claim 23, wherein the first event is at least one of clock setting, a count of a selected parameter, an available capacity of at least a segment of memory, a loss of synchronization between the primary and standby processing systems, and the completion of a transaction.

25. The system of claim 17, wherein the standby processing system has at least one standby memory area comprising an earlier version of the information currently in the at least one memory area and wherein the standby processing system receives, with the at least some of the alterations, a checksum associated with the current information of the at least one memory area, and wherein the standby processing system applies the at least some alterations to the earlier version of the information to form updated information, determines whether the checksum is valid for the updated information, when the checksum is not valid for the updated information, initiates a refresh of the contents of the at least one standby memory area, and, when the checksum is valid for the updated information, copies the updated information to the at least one standby memory area.
